(19) United States
(12) Patent Application Publication
(10) Pub. No.: US 2014/0358643 A1
(43) Pub. Date: Dec. 4, 2014

(54) Systems and Methods for Process Designing by Aligning With Objectives

(71) Applicant: Tata Consultancy Services Limited, Mumbai (IN)

(72) Inventors: Supriya Kummamuru, Hyderabad (IN); Nistala Venkata Padmalata, Hyderabad (IN); Narayana Guru Prasada Lakshmi Mandaleeka, Hyderabad (IN)

(21) Appl. No.: 13/903,078

(22) Filed: May 28, 2013

(51) Int. Cl. G06Q 10/06

(52) U.S. Cl. CPC G06Q 10/0637
USPC 705/7.36

(57) ABSTRACT

Described herein is a system for designing processes in alignment with the business objectives. The system includes an objective formulation module defines a number of business objectives based upon a pre-defined criterion. A process mapping module associates the business objectives to the processes in the organization. The process mapping module maps the processes with the defined business objectives, determines unmapped processes, obtains modified processes based upon gaps within the unmapped processes, and links the mapped and modified processes to a number of functions in the organization. Further, a display module displays linkages of the mapped processes and the modified processes to the business objectives and the functions to enable a user in tracing the mapped processes and the modified processes to the defined business objectives and the functions.

### TECHNICAL FIELD

The present subject matter relates, in general, to organizational management techniques and, in particular, to designing of business processes for an organization.

### BACKGROUND

Organizations perform a variety of functions related to their operations, management, and the nature of products or services as provided by them. Such functions, for their execution, need business processes as well as capabilities of a workforce deployed by the organization. A business process is a collection of inter-related activities or tasks that produce a specific service or product, thereby serving a particular goal of the organization. Such processes are usually based on a step by step procedure and can be visualized with the help of a flowchart in order to acquaint stakeholders of the organization as well as the workforce with the intricacies of the prevalent business processes.

Typically, a business process begins with an objective and ends with the achievement of the objective by producing the service or the product. The business process may also be decomposed into several sub-processes, which have their own purposes, but also contribute to achieving the overall purpose of the main process. The business processes are also linked to the functions of the each employee, who is a part of the workforce within the organization.

### BRIEF DESCRIPTION OF DRAWINGS

The above and other features, aspects, and advantages of the subject matter will be better understood with regard to the following description, appended claims, and accompanying figures. In the figures, the left-most digit(s) of a reference number identifies the figure in which the reference number first appears. The use of the same reference number in different figures indicates similar or identical items.

FIG. 1 illustrates a network environment implementing a system for process designing in an organization, in accordance with an implementation of the present subject matter.

FIG. 2 illustrates a process designing system, in accordance with an implementation of the present subject matter.

FIG. 3 illustrates a method for designing business processes in an organization based upon business objectives, according to an implementation of the present subject matter.

### DETAILED DESCRIPTION

The present subject matter generally relates to organizational management techniques and, in particular, to designing business processes for the organization. Further, the present subject matter enables the establishment of a relationship between business objectives, business processes as well as functions within the organization by aligning the business objectives with the business processes and functions.

A business process includes a collection of inter-related activities or tasks that are performed to produce a specific service or product. Business Processes in an organization are designed to add value to the client and typically do not include activities that are averse to client requirements. A well designed business process benefits the organization by increasing effectiveness in the form of value to the client and increased efficiency in the form of less expenditure incurred by the organization over developing the products and providing services.

The business processes can be designed through a number of methods and techniques. Conventional process designing techniques focus solely upon the prevalent business processes to identify elements of improvements within the same. For doing so, the conventional techniques depend upon a technical know how of a process designer and suggestions from employees within the organization to develop or improvise the existing process. As a result, the conventional process designing techniques either neglect or partially consider the business objectives of the organization for designing the business processes.

Further, it may be difficult and time consuming to identify the real business objectives associated with the prevalent processes. Due to negligence or partial consideration of the business objectives, many business objectives as such remain unconsidered. Accordingly, the unconsidered objectives remain unfulfilled or get realized after a substantial time delay. This results in ineffective customer satisfaction and attainment of the business objectives in a cost-inefficient manner.

The present subject matter describes systems and methods to design business processes of an organization in alignment with business objectives. The designed business processes are further linked to various functions in the organization to find owners linked to the business processes.

In an implementation of the present subject matter, a number of business objectives are defined based on various criteria namely, stakeholder analysis, customer or client requirements, organization goals, etc. The defined business objectives are gathered and used as the basis to design new business processes or modify the prevalent business processes to meet the business objective. The resulting processes including prevalent, new and modified business processes can be traced both to the business objectives and functions in the organization to ensure ownership of the business processes and the functions.

In an implementation, the business objectives are defined by selecting relevant business objectives from a received set of business objectives. The set of business objectives may be received from a designated professional in the organization. The selection is based on requirements of the stakeholders, requirements of the customer or client, presence of a mechanism or technical resource within the organization for realizing the objectives, and goals of the organization. In an example, the relevant business objectives are filtered from the received business objectives on the basis of the aforementioned criteria. The non-relevant business objectives may be discarded or quarantined for future usage.

Further, the defined business objectives are mapped or associated with prevalent business processes of the organization to check the utility of the business processes. This facilitates in identifying which business processes out of the existing business processes are able to fully map with one or more defined business objectives and which are not. In case, if some business processes are found to be not fulfilling the defined business objectives, either the loopholes in such prevalent business processes may be plugged or new business processes may be designed. For the business processes not mapping or partially mapping with the defined business objectives, the gaps or required capabilities within such business processes are identified by the organization. Based on the identified gaps, modification in the existing business processes is done by the organization. In addition, new business processes may also be designed by the organization to correspond to the unmapped business objectives.

Further, the prevalent mapped business processes, the new business processes and the modified business processes are linked or mapped to various functions of the organization. As each function has one ore more associated owners within the organization, ownership of an associated owner also gets automatically linked to all types of business processes and accordingly to the business objectives. Like the business processes, gaps may be identified in the functions that are partially mapping to the processes and accordingly, such functions may be modified. Further, new functions may also be designed.

Further, linkages of each of the business processes with the business objectives and functions are displayed to enable a user in tracing each of the business processes to the business objectives and functions. The linkages may be displayed in the form of a matrix. In an example, the matrix is a four dimensional matrix representing the business processes, the business objectives, the functions and the identified gaps as four elements or dimensions of the matrix. In an implementation, the linkages may be denoted and displayed in the form of a layout, a map or a tree. The tracing as a result of the display of the linkages facilitates further identification of the gaps in the business processes and functions. The identification of gaps in functions and the business processes is important for taking appropriate corrective measures in, so as to further ensure a timely delivery of the products or services of the organization.

Thus, the methodology of the present subject matter provides a framework to facilitate designing the business processes while keeping the present as well as future goals of the organization in view. This may be attributed to the involvement of stakeholders as well other customers' perspectives in defining the business objectives by the objective formulation module. Further, the timely identification of gaps in the business processes and functions enabled by the process mapping module helps in reformation of the organizational management as well as increase in productivity within the organization, thereby leading to a culture of best industrial practices and adherence to international norms like six sigma rating. In addition, the display of linkages among the business objectives, the business processes and the functions keeps the workforce of the organization acquainted with the operational architecture of the organization.

These and other features and advantages of the process designing system are described in further detail in conjunction with the following figures.

The following disclosure describes the systems and methods for business process designing. While aspects of the described systems and methods can be implemented in any number of different computing systems, environments, and/or configurations, implementations of the process designing system have been described in the context of the following exemplary system(s) and method(s).

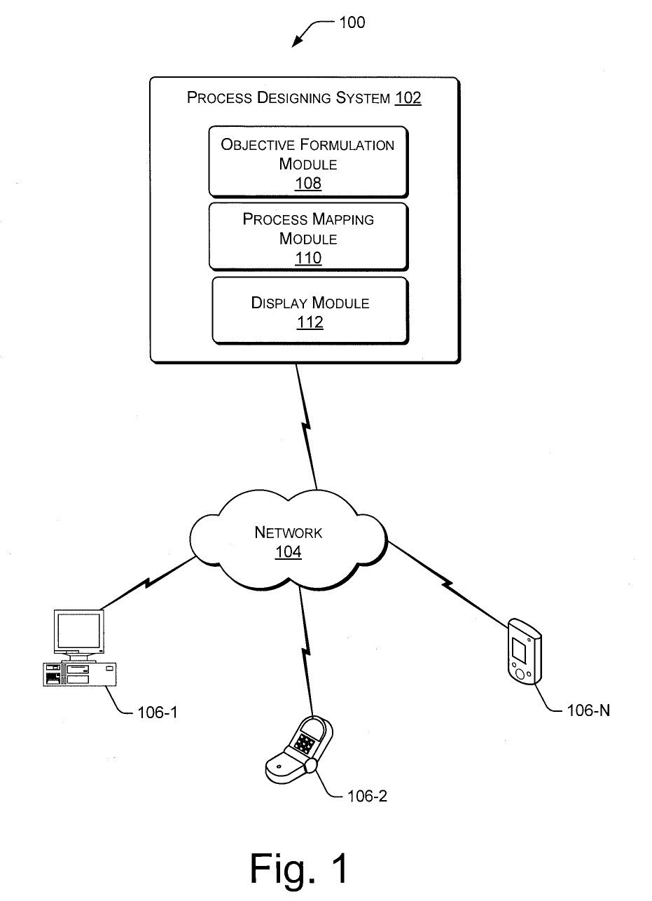

FIG. 1 illustrates a network environment 100 implementing a process designing system 102 for an organization, according to an implementation of the present subject matter. The process designing system 102 is configured to design business processes based upon business objectives of the organization. For the sake of simplicity, the business processes have been hereinafter referred to as processes.

In the network environment 100, the process designing system 102 is communicatively coupled to a network 104. One or more client devices 106-1, 106-2, . . . 106-N, collectively referred to as client devices 106, are also communicatively coupled to the network 104. The client devices 106 include laptops, desktop computers, PDA (personal digital assistant), tablets, smart phones and other similar devices. Communication between the client devices 106 and the process designing system 102 facilitates in execution of the process designing by the authorized employees or consultants associated with the organization, while being geographically separated from the organization.

The process designing system 102 can be implemented as a computing device connected to the network 104. For instance, the process designing system 102 may be implemented as mainframe computers, workstations, personal computers, desktop computers, multiprocessor systems, laptops, network computers, minicomputers, servers and the like.

The process designing system 102 is connected to the client devices 106 through the network 104. Communication links between the client devices 106 and process designing system 102 are enabled through a desired form of connections, for example, via dial-up modem connections, cable links, digital subscriber lines (DSL), wireless or satellite links, or any other suitable form of communication.

The network 104 may be a wireless network, a wired network, or a combination thereof. The network 104 can also be an individual network or a collection of many such individual networks interconnected with each other and functioning as a single large network, e.g., the internet or an intranet. The network 104 can be implemented as one of the different types of networks, such as intranet, local area network (LAN), wide area network (WAN), the internet and such. The network 104 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 104 may include network devices, such as network switches, hubs, routers, host bus adapters (HBAs), for providing a link between the process designing system 102 and the client devices 106. The network devices within the network 104 may interact with the process designing system 102 and the client devices 106 through communication links.

The process designing system 102 facilitates in defining business objectives for an organization, and enables the organization to modify existing processes and design new processes of the organization based upon the business objectives. The original processes, the modified processes and the new designed processes are obtained by the process designing system 102 and mapped to various functions in the organization. As a result of such mapping with the functions, owners discharging various functions in the organization can be linked with all of these processes, and in turn the objectives.

In an implementation, the process designing system 102 includes an objective formulation module 108, a process mapping module 110 and a display module 112. The objective formulation module 108 defines the business objectives by selecting a set of relevant business objectives from a received set of business objectives, such selection being based on various criteria namely, stakeholder analysis, customer/client requirements, organization goals etc. The set of business objectives may be received from a designated professional working for the organization or from a database storing the business objectives. In an implementation, the objective formulation module 108 filters the relevant business objectives out of received objectives of the organization based upon requirements of stakeholders in an organization, particular or specific requirements of the customer or client, presence of a technical resource or expertise within the organization for realizing the objectives, and fulfillment of the goals of the organization. In an example, the stakeholders include investors, senior management, owners, sponsors, venture capitalists, etc, associated with the organization.

For the purpose of defining the business objectives, the objective formulation module 108 may explore the entire set of received business objectives and shortlists the relevant business objectives on the basis of the aforementioned criteria. The non-relevant objectives may be discarded or quarantined for future usage.

Further, the process mapping module 110 receives the defined business objectives and uses the same as the basis to enable the organization in designing new processes or modifying the prevalent processes. For such purpose, the process mapping module 110 maps or associates the defined business objectives to current processes of the organization either for designing new processes or plugging the loopholes of the existing processes. In an implementation, the process mapping module 110 identifies processes which help in realizing the defined business objectives and maps both. Based on the existing processes that do not map or partially map to the defined business objectives, gaps are identified by the organization. Further based on the identified gaps, either modifications in the existing processes are performed or new processes are designed by the organization. In addition, new processes may also be designed by the organization with respect to the unmapped business objectives.

The process mapping module 110 obtains the modified and the new processes from the organization. Further, each of the mapped processes, the new processes, and the modified processes are linked to at least one corresponding function out of a number of functions in the organization. Again, the functions not mapping to any of the processes may be quarantined for future usage, or discarded, or merged with any of the mapped functions for supportive role. Further, as each function has by default an associated owner, each process gets automatically linked to an owner based on the mapping.

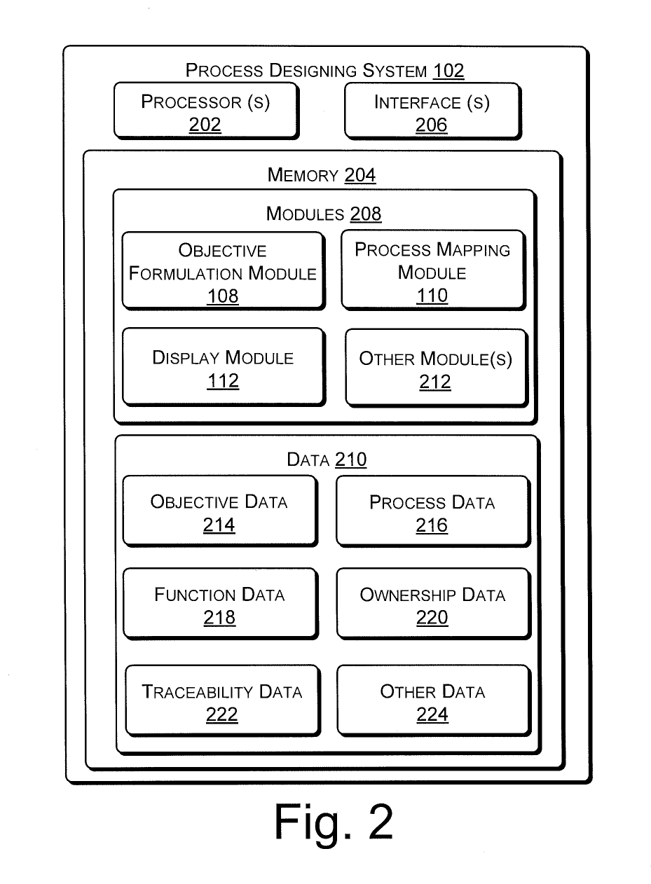

Further, the display module 112 provides a display of linkages of the business objectives, the processes and the functions to a user. Such display helps the user in tracing the processes to the business objectives and the functions of the organization. In addition, owners are also traced to the processes and the associated business objectives. For such purpose, the user traces the functions linked to the owners to the mapped processes, the new processes and the modified processes, which are in turn traced to one or more business objectives. In an example, the display of such linkages among the functions, processes and objectives may be done by a producing a diagrammatic or illustrative representation in the form a matrix, a tree, a layout, a map or an excel sheet. An exemplary diagrammatic representation has been depicted in the form of Table 1 as a part of description of FIG. 2.

By producing a diagrammatic representation, the display module 112 enables the organization in further identifying of gaps, if any, in the finalized processes and the same may be plugged in real-time by the organization to ensure efficiency of all the processes. Further, as a result of tracing, even the gaps, if any, in the finalized functions also get identified and appropriate remedial measures may be taken at real-time by the organization. A simultaneous plugging of gaps in both the processes as well as the functions at the real-time cumulatively leads to a timely delivery of the end products and services of the organization. These and other aspects are described further in conjunction with FIG. 2.

FIG. 2 illustrates the process designing system 102 in accordance with one implementation of the present subject matter. The process designing system 102 includes processor(s) 202, a memory 204 coupled to the processor(s) 202 and I/O interface(s), referred to as interface(s) 206 to facilitate communication with other devices and systems.

The processor(s) 202 can be a single processing unit or a combination of multiple processing units. The processor(s) 202 can be implemented as one or more microprocessors, microcomputers, microcontrollers, digital signal processors, central processing units, state machines, logic circuitries, or any devices that manipulate signals based on operational instructions. Among other capabilities, the processor(s) 202 are configured to fetch and execute computer-readable instructions and data stored in the memory 204.

The interface(s) 206 may include a variety of software and hardware interfaces, for example, interface for peripheral device(s) such as a keyboard, a mouse, an external memory, a printer, etc. Further, the interface(s) 206 may enable the process designing system 102 to communicate with other computing devices, such as web servers and external databases. The interfaces 206 may facilitate multiple communications within a wide variety of protocols and networks, such as the network 104, including wired networks, e.g., LAN, cable, etc., and wireless networks, e.g., WLAN, cellular, satellite, etc. The interface(s) 206 may include one or more ports for connecting the process designing system 102 to the network 104 and or the client devices 106.

The memory 204 can include any computer-readable medium known in the art including, for example, volatile memory such as static random access memory (SRAM) and dynamic random access memory (DRAM), and/or non-volatile memory, such as read only memory (ROM), erasable programmable ROM, flash memories, hard disks, optical disks, and magnetic tapes. The memory 204 includes modules 208 and data 210.

The modules 208 include the objective formulation module 108, the process mapping module no, the display module 112, and other module(s) 212. The other module(s) 212, in general, include routines, programs, objects, components, data structures, etc., that perform particular task or implement particular abstract data types and may include programs that supplement applications implemented by the process designing system 102.

As described earlier, the objective formulation module 108 defines a number of business objectives which are then gathered by the process mapping module 110 to design new processes or modify the prevalent processes. The prevalent mapped, new and modified processes are traced by the user both to one or more business objectives and functions in the organization to ensure ownership of the processes and the functions for meeting the business objectives. Such tracing by the user is enabled on observing a display provided by the display module 112.

In operation, a user of the one or more of the client devices 106 may start interacting with the process designing system 102. Such user may be an employee or consultant for the organization appointed for the purpose of developing and improvising the organizational processes. Subsequently, the process designing system 102 retrieves a number of existing business objectives associated with the organization from such user. Such objectives may also include some objectives that have become redundant over a period of time, thereby being non-relevant. Accordingly, the objective formulation module 108 operates to filter the relevant business objectives from the entire set of business objectives based upon various types of criteria that includes stakeholder analysis, customer/client requirements, availability of technological resources with the organization, the organization goals etc. In an implementation, the objective formulation module 108 may also be updated with new business objectives at real-time or with additional criteria for filtering the relevant business objectives, based upon the discretion of the organization. The business objectives considered as non-relevant may be discarded or kept aside for future use by the organization.

For the purposes of storing the filtered and relevant business objectives, the data 210 includes an objective data 214. The objective data 214 stores various types of aforesaid criteria, which may be used by the objective formulation module 108 to filter the relevant business objectives. The filtered business objectives may be classified in the form of stakeholder objectives, customer objectives, organizational objectives, etc, and the same can be stored in the objective data 214.

Thereafter, the process mapping module 110 receives the relevant business objectives from the objective formulation module 108 and retrieves a list of prevalent processes within the organization. These processes are mapped with the relevant business objectives to establish links of each business objective with at least one process.

In an implementation, the process mapping module 110 accomplishes such mapping between the relevant business objectives and the processes on the basis of a relation of the business objectives and a number of functional attributes of the processes. The functional attributes of the prevalent processes may be pre-defined by a designated professional of the organization and their relation with the business objectives may be ascertained by the process mapping module 110. For such ascertaining, a count of the business objectives and the functional attributes of the processes that relate with each other are ascertained by the process mapping module 110. The count of the related functional attributes exceeding a pre-defined threshold value set by the process mapping module 110 for a particular business objective-process combination is proclaimed as mapping between the both.

As a result of such mapping, the processes can be classified by the process mapping module 110 into mapped processes and unmapped processes. The mapped processes may be considered as original processes that map with at least one business objective and do not require a modification or improvisation. However, the unmapped processes are considered to be under-developed and require improvisation. The unmapped processes may denote processes that have either partially mapped with one or more business objectives or not mapped at all.

Accordingly, each of the determined unmapped process is analyzed by the process mapping module 110 by assessing its degree of unmapping with the one or more relevant business objectives. Based upon such degree, the unmapped processes are provided by the process mapping module 110 to the organization, and a number of gaps between the unmapped processes and the business objectives are identified by the organization. Such gaps may also be termed as additional capabilities or features to be incorporated within the unmapped processes. Thereafter, based upon the discretion exercised by the organization, the unmapped process may either be modified or completely overhauled so as to develop new processes based upon the identified gaps. In an example, some of the processes which are completely unmapping with the relevant business objectives may be discarded by the organization. The modified and newly designed or new processes are obtained by the process mapping module 110 from the organization.

Further, the process mapping module 110 also determines a set of unmapped business objectives, which are not mapped to any one of the existing processes, the modified processes or the new processes. Based upon the same, the organization may design additional new processes to map with at least one of these business objectives. In other words, the unmapped business objectives may be provided by the process mapping module 110 to the organization for designing the additional processes.

Further, the process mapping module 110 maps each of the mapped processes, the modified processes and the new processes with one or more prevalent functions within the organization. As aforementioned in terms of implementing business objective-process mapping, the count of related functional attributes exceeding the pre-defined threshold value for a particular process(s)-function(s) combination indicates a mapping between the both.

Based upon the mapping, the process mapping module 110 links every function with the mapped processes, the modified processes and the new processes. Like the modified processes, the organization may also modify some of the functions that partially map with the processes. Such modification may be based upon identification of gaps within the partially mapped functions. The gaps get identified by the organization on the basis of the partial mapping between such functions and the processes as done by the process mapping module 110. The information of the unmapped functions is provided to the organization by the process mapping module 110. The functions modified by the organization are then obtained by the process mapping module 110. Thereafter, the process mapping module 110 maps each of the prevalent and modified functions with the processes and any partial mapping existing between some of the functions and the processes is done away.

In addition, new functions may also be created by the organization in respect of the processes not mapping to any of the functions. The functions that do not completely map to the processes may either be discarded or may be merged with the existing functions for supportive role.

Further, the process mapping module 110 by mapping functions to the processes is able to link the owners to the processes and thereby to the business objectives. The owners include managers or partners of the organization undertaking charge of one or more functions within the organization. Accordingly, the process mapping module 110 is able to establish a chain starting from a business objective and ending at corresponding one or more owners. By virtue of such chain, the business objectives, the processes and the functions of the organization fully map with each other, and the unmapped entities are discarded or quarantined. Accordingly, neither of the business objectives, processes and functions are left in an orphan or unmapped state.

For the purposes of storing data related to various types of processes prevalent within an organization, the data 210 includes a process data 216. The mapped processes, the modified processes and the new processes may be stored under separate categories. The data 210 also includes a function data 218 to store various existing functions of the organization In an implementation, the modified functions or new functions may be further stored within the function data 218 under separate categories. Further, the data 210 includes the ownership data 220 to store a list of existing employees or partners of an organization that are associated with each type of function stored within the function data 218.

Further, the display module 112 receives the aforesaid linked entities from the process mapping module 110 and processes the same so as to provide a display of the linked entities. For the purposes of storage of linked objectives, processes, functions and owners, the data 210 includes the traceability data 222. In an implementation, the traceability data 222 may act as a relational database. The display module 112 also updates the traceability data 222 based upon the updates in the objective data, process data, function data, etc.

Further, the data 210 may also include other data 224 which may be used for other functionalities of the process designing system 102. For example, in one implementation, the other data 224 may include user feedback offered to the processes and functions of the organization.

In an example, the display may be in the form of a four dimensional matrix, as shown in Table 1, having business objectives (O1 to O6), processes (P1 to P6), functions (F1 to F6) and identified gaps (G1 to G5) as the four elements of the matrix.

In Table 1, the symbol ‘X’ denotes the mapping between any two different types of elements. As evident from the table, one type of element may map with one or more of other types of elements. The objectives O1 to O4 denote the objectives that mapped with the unmodified or original processes P1 to P4. Accordingly, the objectives O1 to O4 do not link with any of gaps G1 to G5. The objectives O5 maps with the modified process P5 due to a partial mapping between the objective O5 and an originally existing process. The gaps that formed the basis of modification of the originally existing process to the modified process P5 may be observed as gaps G3 and G4, which in an example correspond to scarcity of workforce and lack of infrastructure. Accordingly, the organization may upgrade the infrastructure and hire additional staff so as to modify an existing process, thereby leading to a modified process P5. Similarly, to achieve the objective 6, which was initially not mapping with any of the existing processes, a new process P6 has been designed by the organization. Such designing of the new process P6 in the present example is based upon the objective O6 as well fulfillment of the requirements, in the form of gaps G1, G2 and G5, as posed by the objective O6.

TABLE 1

| | | | | | | | | | | | | |
|---|---|---|---|---|---|---|---|---|---|---|---|---|
| X | | X | | | | P1 | | | X | | X | |
| | X | X | | | | P2 | | | | | | X |
| X | | | X | | | P3 | | X | | X | | X |
| | X | X | X | | | P4 | | | X | X | | |
| | | | | X | | P5 (Modified) | | X | | | X | |
| | | | | | X | P6 (New) | X | | | X | | X |
| O1 | O2 | O3 | O4 | O5 | O6 | Gaps | F6 (New) | F5 (Modified) | F4 | F3 | F2 | F1 |
| | | | | | X | G1 (Absense | X | | | | | |
| | | | | | | of Technology) | | | | | | |
| | | | | | X | G2 (Training | | X | | | | |
| | | | | | | requirements) | | | | | | |
| | | | | X | | G3 (Scarce | | X | | | | |
| | | | | | | Workforce) | | | | | | |
| | | | | X | | G4 (Infrastructural | X | | | | | |
| | | | | | | requirements) | | | | | | |
| | | | | | X | G5 (Resource | X | | | | | |
| | | | | | | allocation) | | | | | | |

Similarly, the functions F1 to F4 map with the processes P1 to P4 and do not accordingly link with any of the gaps G1 to G5. To map with the modified process P5 and the new process P6, the organization modifies an originally existing function to produce the modified function F5 and designs a new function F6, respectively.

In order to produce the modified function F5, the organization considers the gaps between the modified process P5 and the originally existing functions. In the present example, the gaps G2 and G3 have been considered by the organization to produce the modified function F5. Accordingly, the modified function F5 links with the gaps G2 and G3. However, it may be also possible that modified function F5 maps with an existing process after coming into existence. In the present example, the modified function F5 maps with the unmodified process P3. In addition, for catering to a modified process P5, the correspondingly mapped modified function F5 may be subordinated by the existing unmodified function F2. Accordingly, the modified process P5 also maps with the original function F2.

In order to produce the new function F6 so as to map with the new process P6, the organization considers the requirements arising out of the new process P6 to devise the new function F6. Such requirements may be considered as the gaps G1, G4 and G5 which have been considered by the organization to produce the new function F6. Accordingly, the new function F6 links with the gaps G1, G4 and G5. It may be also possible that the new function F5 is subordinated by one or more existing unmodified functions in catering to the new process P6. Accordingly, in the present exemplary table, the new process P6 maps with both, the new function F6 and the original functions F1 and F3.

It may be understood that although in the present exemplary Table 1, the modified process P5 maps with the modified function F5, it may be possible that a new function is designed by the organization to map with the modified process P5 instead of modifying any existing function. In an example, although not shown in the present exemplary Table 1, the modified process P5 may map with the new function F6.

Further, although not shown as an element of the matrix in the exemplary Table 1, the owner can be shown linked with the processes and objectives by the display module 112 in addition to the existing elements. This is due to the fact that each function is allocated an associated owner or multiple owners in the form a manager, partner or director of the organization. Accordingly, any owner within the organization may be traced to one or more business objectives, through the intermediate link of functions and the processes. Further, instead of the four dimensional matrix, the display module 112 is also configured to display the linked entities of the organization in the form of other diagrammatic representations including layout, tree or a map.

It would also be appreciated that the exemplary table, as provided, exemplifies scenarios where the process designing system 102 is executed for the organization on the whole. However, other forms of process designing system 102 that are not applied for the entire organization, and are rather applied in terms of specific projects, departments, divisions, etc., in the organization would also be included within the scope of the present subject matter.

In an exemplary implementation of the present subject matter, the process designing system 102 may be implemented in a Fast-moving consumer goods (FMCG) based industry to facilitate the designing of processes within the industry. However, the application of the process designing system 102 shall not be construed as limiting to the FMCG industry and may be extended to cover other types of industries based on manufacturing, information technology, information technology enabled services, consultancy, business process outsourcing, power, etc.

In an example, the business objectives of an FMCG industry include: (a) to cater to diverse market segments, (b) to improve service to customers, (c) to maximize profitability through realizing sales and minimizing incurred expenditure, (d) to improve relations with market distributors as well as vendors by ensuring high quality and timely supplies of the goods, etc. In addition, the FMCG industry may also have some business promotion and advertisement centric objectives. Such objectives may include: (e) to enhance a corporate image of the industry in the market, (f) to make the industry a household name nationally or internationally etc. On receiving such business objectives from the designated professional of the FMCG industry, the process designing system 102 may filter the relevant business objectives and discard the non-relevant objectives based on the criteria as described previously. For the sake of brevity, in the present example, all of the abovementioned business objectives may be considered as relevant business objectives.

Further, in order to achieve the business objectives, the industry has a number of prevalent processes based upon marketing strategies. Some examples of such processes include processes for (a) devising pricing strategy and planning market penetration, (b) planning new products, (c) reviewing product quality and forecasting the product demand, (d) assessing a sales potential of the industry, (e) obtaining market information & benchmarking, (f) advertisement and promotion of products, etc. Accordingly, the process designing system 102 maps the relevant objectives with these processes, thereby ascertaining whether any process has been left unmapped or partly mapped. The unmapped or partly mapped processes may be improvised based upon loopholes or gaps within such processes, or altogether a new process be designed, for meeting or achieving the business objectives. Considering the present exemplary implementation, the existing business process of “obtaining market information and benchmarking” may be modified so as to include usage of various types of electronic and print advertising media for comprehensively meeting the relevant business objective of “to make the industry a household name nationally or internationally”. In addition, a new process may be designed by the industry based on the unmapped relevant business objective of “to enhance a corporate image of the industry in the market”. Such new process may be “exploring avenues and resources for participation in business conferences and conclaves organized by various business associations”.

Further, in order to execute the prevalent processes, modified processes and the new processes, the industry has a number of prevalent functions. The examples of such functions in the FMCG industry may include: (a) Corporate Planning, (b) Marketing, (c) Advertising & Promotion, (d) Product Development, (e) Raw Material Management, (f) Production Quality, (g) Engineering, (h) Sales, (i) Finance & Accounting, (j) Human Resources, etc. Accordingly, these exemplary functions are then mapped with the all the prevalent processes, modified processes, and the new processes. On the lines of processes, any of the functions may either be modified or a new function may be created by the organization depending upon the extent of mapping with the processes. In the present example, a new function related to quality control may be designed by the organization to map with the process “reviewing product quality and forecasting the product demand”.

On the basis of mapping of the functions with the processes and in turn to the relevant business objectives, the employees of the FMCG industry who directly handle the functions can be observed as linked with a corresponding process and in turn to a corresponding relevant business objective. As already described in terms of Table 1, the process designing system 102 displays the linkage between the relevant business objectives, the processes, and the functions, thereby enabling the industry in tracing the processes and functions to the relevant business objectives.

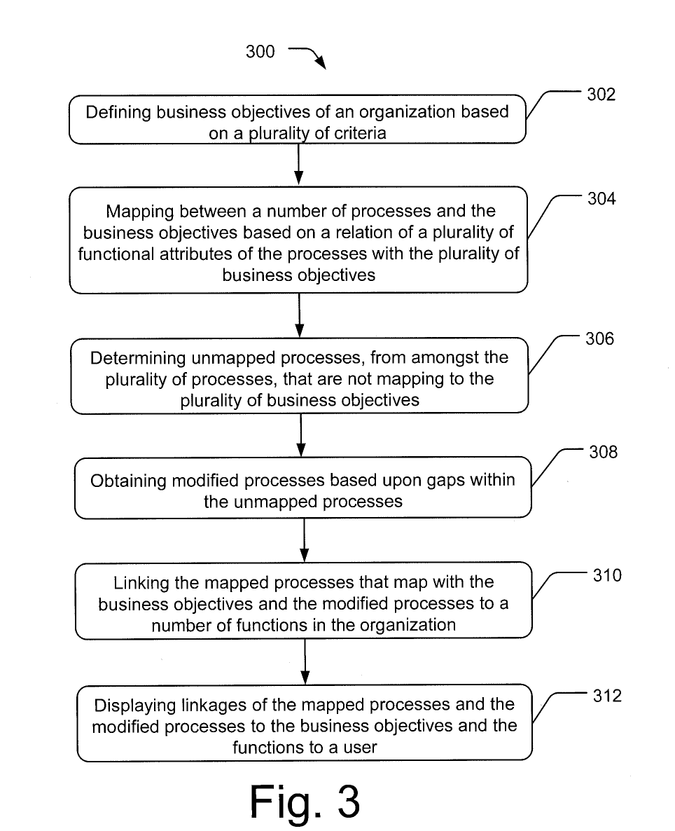

FIG. 3 illustrates a method 300 for designing processes in an organization based upon business objectives, according to an implementation of the present subject matter. The method 300 is implemented in the process designing system 102. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communication network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300, or an alternative method. Additionally, individual blocks may be deleted from the method 300 without departing from the spirit and scope of the subject matter described herein. Furthermore, the method 300 can be implemented in any suitable hardware, software, firmware, or combination thereof. The method 300 is presently provided for designing processes by aligning with these with the objectives of the organization. It will be apparent that the method 300 may be implemented for designing the processes based on other additional parameters with modifications as known by those skilled in the art.

At block 302, a number of business objectives of an organization are defined. Such defining takes place on the basis of a number of criterion including a stakeholder analysis, client requirements, goals of the organization, etc. The defining of the number of the business objectives includes filtering a relevant number of business objectives from a received set of objectives, such that filtering is performed based upon the aforementioned criteria. The received set of objectives is provided by a designated professional of the organization.

At block 304, a number of processes are mapped with the defined business objectives. Such processes are existing or prevalent processes within the organization. Each of the processes may map with one ore more defined business objective.

At block 306, unmapped processes that do not map with one or more of the business objectives are determined based upon the mapping performed in block 304. Such unmapped processes may include the processes that partially map with one or more defined business objectives and the processes that do not map at all.

At block 308, modified processes based upon a number of gaps within the unmapped processes, as present in the block 306, are obtained. The organization modifies the unmapped processes, based upon a number of gaps therein, to enable a full mapping with the corresponding business objectives.

At block 310, the mapped processes that map with the business objectives and the modified processes are linked to a number of functions in the organization. As each function has one or more authorized owners, an associated ownership of each of the mapped processes and the modified processes is ascertained.

At block 312, linkages of the mapped processes and the modified processes to the business objectives and the functions are displayed to a user. As mentioned before, such display of the linkages takes place as a diagrammatic representation in the form of a matrix, a layout, a tree or a map to enable a user in tracing the mapped processes and the modified processes to the business objectives and functions. The diagrammatic representation thus generated would impart a pictorial utility to the user and the organization in observing the inter-connections among the objectives, processes, and functions to a greater extent, thereby increasing the chance of a quick finding of an objective associated with any process, function or the owner. Specifically, the diagrammatic representation in the form of layout, map, etc., helps in clearly demarcating ownership of different employees within the organization.

In an implementation, unmapped business objectives, that are not mapped to any one or more of processes during the mapping performed in step 304 may be determined from amongst the number of business objectives. Accordingly, a number of new processes based on the unmapped business objectives may be obtained and then at least one function is linked to the new processes to ascertain an associated ownership of the new processes.

Further, the tracing in the form of a diagrammatic representation may lead to an additional identification of gaps, if any, in the finalized processes and functions. The identification of such additional gaps is important for the organization for taking further corrective measures in terms of the processes and functions at an appropriate moment, so as to substantially secure a timely delivery of the end products or services of the organization.

Thus the process designing system 102 as explained provides a systematic framework to facilitate designing of the processes, keeping the present as well as future goals of the organization in consideration. The consideration of the future goals is achieved by involving perspective of different types of stake-holders at the initial stage of defining the business objectives. In addition, the gap finding in the functions as well as processes may be done concurrently, thereby leading to time efficiency and prevention of losses.

Although implementations for the process designing system 102 for designing the processes based in alignment with the business objectives have been described in language specific to structural features and/or methods, it is to be understood that the present subject matter is not necessarily limited to the specific features or methods described. Rather, the specific features and methods are disclosed as exemplary implementations for the process designing system 102.

I/We claim:

1. A process designing system for designing processes in an organization, the process designing system comprising:
a processor; and
an objective formulation module coupled to the processor to define a plurality of business objectives based on a stakeholder analysis, client requirements, and goals of the organization;
a process mapping module coupled to the processor to associate the plurality of business objectives to a plurality of processes in the organization, wherein the process mapping module is configured to:
establish a mapping between the plurality of processes and the plurality of business objectives based on a relation of a plurality of functional attributes of the processes with the plurality of business objectives;
determine unmapped processes, from amongst the plurality of processes, that are not mapping to at least one of the plurality of business objectives;
obtain modified processes based upon gaps within the unmapped processes; and
link mapped processes that map with at least one of the plurality of business objectives and the modified processes to a plurality of functions in the organization to ascertain an associated ownership of each of the mapped processes and the modified processes; and
a display module coupled to the processor to display linkages of the mapped processes and the modified processes to the plurality of business objectives and to the plurality of functions to enable a user in tracing the mapped processes and the modified processes to the plurality of business objectives and the plurality of functions.

2. The process designing system as claimed in claim 1, wherein the process mapping module is further configured to:
determine unmapped business objectives, from amongst the plurality of business objectives, that are not mapped to at least one of the plurality of processes;
obtain at least one new process based on the unmapped business objectives; and
link the at least one new process to at least one of the plurality of functions to ascertain an associated ownership of the at least one new process.

3. The process designing system as claimed in claim 2, wherein the display module displays linkages of the at least one new process to the plurality of business objectives and to the plurality of functions to enable the user in tracing the at least one new process to the plurality of business objectives and the plurality of functions.

4. The process designing system as claimed in claim 1, wherein the objective formulation module is configured to define the plurality of business objectives by filtering the plurality of business objectives as relevant objectives out of received business objectives, wherein the filtering is based upon at least one of the stakeholder analysis, the client requirements, and the goals of the organization.

5. The process designing system as claimed in claim 1, wherein the objective formulation module is further configured to define the plurality of business objectives based upon presence of at least one technical resource within the organization.

6. The process designing system as claimed in claim 1, wherein the display module is configured to display a matrix for displaying the linkages.

7. The process designing system as claimed in claim 6, wherein the matrix is a four dimensional matrix comprising processes, the plurality of business objectives, the plurality of functions and the gaps as four elements of the matrix.

8. The process designing system as claimed in claim 1, wherein the display module is configured to exhibit at least one of a layout, a map or a tree to denote the linkages.

9. A computer-implemented method for designing processes for an organization, the method comprising:
defining a plurality of business objectives based on a stakeholder analysis, client requirements, and goals of the organization;
establishing a mapping between plurality of processes and the plurality of business objectives based on a relation of a plurality of functional attributes of the processes with a plurality of business objectives;
determining unmapped processes, from amongst the plurality of processes, that are not mapping to at least one of the plurality of business objectives;
obtaining modified processes based upon gaps within the unmapped processes;
linking the mapped processes that map with at least one of the plurality of business objectives and the modified processes to a plurality of functions in the organization to ascertain an associated ownership of each of the mapped processes and the modified processes; and
displaying linkages of the mapped processes and the modified processes to the plurality of business objectives and to the plurality of functions to enable a user in tracing each of the mapped processes and the modified processes to the plurality of business objectives and the plurality of functions.

10. The method as claimed in claim 9, further comprising:
determining unmapped business objectives, from amongst the plurality of business objectives, that are not mapped to at least one of the plurality of processes;
obtaining at least one new process based on the unmapped business objectives;
linking the at least one new process to at least one of the plurality of functions to ascertain an associated ownership of the at least one new process; and
displaying linkages of the at least one new process to the plurality of business objectives and the plurality of functions to enable the user in tracing the at least one new process to the plurality of business objectives and the plurality of functions.

11. The method as claimed in claim 9, wherein the defining comprises filtering the plurality of business objectives as relevant objectives out of received business objectives based upon at least one of the stakeholder analysis, the client requirements, and the goals of the organization.

12. The method as claimed in claim 11, wherein the defining further comprises defining the plurality of business objectives based upon presence of at least one technical resource within the organization.

13. The method as claimed in claim 9, wherein the displaying comprises displaying a matrix for displaying the linkages.

14. The method as claimed in claim 13, wherein the matrix is a four dimensional matrix comprising processes, the plurality of business objectives, the plurality of functions and the gaps as four elements of the matrix.

15. A non-transitory computer-readable medium comprising instructions executable by a processor to execute a method for process designing for an organization, the method comprising:
defining a plurality of business objectives based on a stakeholder analysis, client requirements, and goals of the organization;
establishing mapping between plurality of processes and the plurality of business objectives based on a relation of a plurality of functional attributes of the processes with a plurality of business objectives;
determining unmapped processes, from amongst the plurality of processes that are not mapping to at least one of the plurality of business objectives;
obtaining modified processes based upon gaps within the unmapped processes;
linking the mapped processes that map with at least one of the plurality of business objectives and the modified processes to a plurality of functions in the organization to ascertain an associated ownership of each of the mapped processes and the modified processes; and
displaying linkages of the mapped processes and the modified processes to the plurality of business objectives and to the plurality of functions to enable a user in tracing the mapped processes and the modified processes to the plurality of business objectives and the plurality of functions.
